(19) United States
(12) Patent Application Publication
(10) Pub. No.: US 2019/0105138 A1
(43) Pub. Date: Apr. 11, 2019

(54) DENTAL CLEANING TOOL INCLUDING AT LEAST ONE MOVEABLE TOOL

(71) Applicant: World Wide Daily Holdings Company Limited, Hong Kong (CN)

(72) Inventor: Chun Yuen TO, Hong Kong (CN)

(21) Appl. No.: 16/150,863

(22) Filed: Oct. 3, 2018

Related U.S. Application Data
(63) Continuation of application No. PCT/CN2017/105724, filed on Oct. 11, 2017.

(51) Int. Cl. A61C 15/04

(52) U.S. Cl. CPC A61C 15/043; A61C 15/02; A61C 15/041; A61C 15/046

(57) ABSTRACT

A dental cleaning tool includes a handle defining a longitudinal axis of the dental cleaning tool and a floss holder having at least one strand of floss coupled thereto. The dental cleaning tool also includes a toothpick formed as one piece with the handle and spaced from the floss holder such that the handle is disposed between the toothpick and the floss holder. The dental cleaning tool further includes a pivotable dental tool pivotably coupled to the handle. The pivotable dental tool is selectively transitionable between a first, stow position and a second, use position.

### CROSS REFERENCE TO RELATED APPLICATIONS

This application is a continuation of International Patent Application No. PCT/CN2017/105724, filed Oct. 11, 2017, and is hereby incorporated by reference in its entirety.

### FIELD

The field of this disclosure relates generally to dental cleaning tools, and more specifically, to a dental cleaning tool including at least one moveable, secondary dental cleaning tool.

### BACKGROUND

Dental cleaning tools are used to remove food remnants and/or build-up from the surface of or between teeth. As a result, some known dental cleaning tools include a brush for cleaning the surface of teeth and other known dental cleaning tools include floss and/or a pick for removing or loosening food remnants (or other debris) lodged between adjacent teeth. However, often known dental cleaning tools can be difficult for a user to manipulate because the dental cleaning tool has to be at least partially inserted inside the user's mouth. Moreover, the user has to hold the dental cleaning tool awkwardly to reach and clean teeth located in the back of the mouth. Thus, known dental cleaning tools are difficult to use on or between teeth located in or near the back of the mouth. In additional, the user often has to switch between discrete tools (e.g., a brush, floss, and/or a pick) to realize the various benefits of each of these tools.

Some conventional dental cleaning tools include combinations of floss, a pick, and/or a brush, which often exacerbates the difficulty of using the dental cleaning tool. For example, the user may have to hold and manipulate the dental cleaning tool in a manner that is uncomfortable to hold or have inserted into one's mouth. Additionally, the floss, pick, and/or brush may obstruct use of the other components of the dental cleaning tool. For example, the floss, pick, or brush may be attached such that the user has difficulty positioning other portions of the dental cleaning tool inside the user's mouth. As a result, some users may skip or ineffectively clean portions of their teeth to avoid discomfort.

Accordingly, there is a need for improved dental cleaning tools that combine a number of dental cleaning tools and are comfortable to use in an easy and effective manner.

### BRIEF DESCRIPTION

In one aspect, a dental cleaning tool includes a handle defining a longitudinal axis of the dental cleaning tool and a floss holder having at least one strand of floss coupled thereto. The dental cleaning tool also includes a toothpick formed as one piece with the handle and spaced from the floss holder such that the handle is disposed between the toothpick and the floss holder. The dental cleaning tool further includes a pivotable dental tool pivotably coupled to the handle. The pivotable dental tool is selectively transitionable between a first, stow position and a second, use position.

In another aspect, a dental cleaning tool includes a handle defining a longitudinal axis of the dental cleaning tool and a floss holder having at least one strand of floss coupled thereto. The dental cleaning tool also includes a toothpick formed as one piece with the handle and spaced from the floss holder such that the handle is disposed between the toothpick and the floss holder. The dental cleaning tool further includes a detachable dental tool selectively transitionable between a first, stow position in which the detachable dental tool is removably coupled to the handle and a second, use position.

In yet another aspect, a dental cleaning tool includes a handle defining a longitudinal axis of the dental cleaning tool and a floss holder having at least one strand of floss coupled thereto. The dental cleaning tool also includes a toothpick spaced from the floss holder such that the handle is disposed between the toothpick and the floss holder. A moveable dental tool is coupled to the handle and is selectively moveable between a first, stow position and a second, use position about a pivot axis perpendicular to the longitudinal axis of the handle. A distal end of the moveable dental tool extends beyond the floss holder in the second, use position.

### BRIEF DESCRIPTION OF THE DRAWINGS

FIG. 1 is a side view of one suitable embodiment of a dental cleaning tool including a pivotable brush tool in a first, stow position.

FIG. 2 is a cross-sectional view of the dental cleaning tool along line 2-2 shown in FIG. 1.

FIG. 3 is an end view of the pivotable brush tool.

FIG. 4 is a cross-sectional view of the dental cleaning tool along line 4-4 shown in FIG. 1 depicting the pivotable brush transitioning from the first, stow position to a second, use position.

FIG. 5 is a side view of the dental cleaning tool shown in FIG. 1 with the pivotable brush in the second, use position.

FIG. 6 is a side view of another suitable embodiment of a dental cleaning tool including a detachable brush tool in a first, stow position.

FIG. 7 is a top view of the detachable brush tool shown in FIG. 6.

FIG. 8 is a cross-sectional view of the dental cleaning tool along line 8-8 shown in FIG. 6 with the detachable brush tool in the first, stow position.

FIG. 9 is a cross-sectional view of the dental cleaning tool along line 9-9 shown in FIG. 6 with the detachable brush tool in the second, use position.

FIG. 10 is a side view of another suitable embodiment of a dental cleaning tool including a pivotable brush tool shown in a first, stow position.

FIG. 11 is a cross-sectional view of the dental cleaning tool along line 11-11 shown in FIG. 10.

FIG. 12 is a side view of the dental cleaning tool shown in FIG. 11 with the pivotable brush in the second, use position.

FIG. 13 is a side view of another suitable embodiment a dental cleaning tool with a detachable brush tool shown in a first, stow position.

FIG. 14 is a cross-sectional view of the dental cleaning tool shown in FIG. 13 with the detachable dental tool in the first, stow position.

FIG. 15 is a cross-sectional view of the dental cleaning tool shown in FIG. 13 with the detachable dental tool in a second, use position.

### DETAILED DESCRIPTION OF THE DRAWINGS

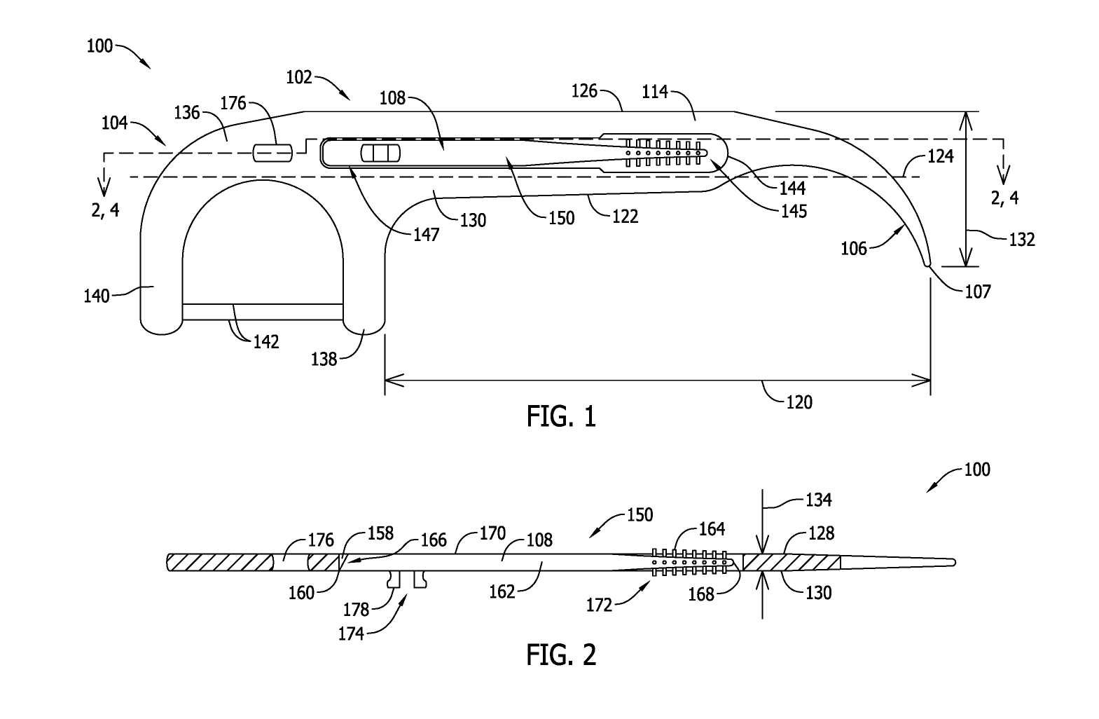

FIGS. 1-5 illustrate one suitable embodiment of a dental cleaning tool, indicated generally at 100, of the present disclosure. As seen therein, the illustrated dental cleaning tool 100 includes a handle 102, a floss holder 104, an integrally formed toothpick 106, and a pivotable brush tool 108 (broadly, a “pivotable dental tool”). It is understood that in some other suitable embodiments that do not depart from some of the aspects of this disclosure, the dental cleaning tool 100 may include any combination(s) of the floss holder 104, the toothpick 106, and the pivotable brush tool 108. It is further contemplated that although the pivotable dental tool is shown and described as a brush, the pivotable dental tool may alternatively including a different dental tool, such as a toothpick tool or floss tool, without departing from the scope of the present disclosure.

As illustrated in FIG. 1, the handle 102 includes a grip portion 114 positioned between the floss handle 104 and the toothpick 106. In the illustrated embodiment, the handle 102 has a length 120 measured between the floss holder 104 and a distal end of the toothpick 106 along a longitudinal axis 124 of the dental cleaning tool 100, which extends through the handle 102. In suitable embodiments, the length 120 of the handle 102 may be any measurement that enables the dental cleaning tool 100 to function as described herein. Suitably, the length 120 is in the range between about 43 mm and about 52 mm. In the illustrated embodiment, for example, the length 120 of the handle 102 is approximately 48 mm.

In the illustrated embodiment and as best seen in FIGS. 1 and 2, the handle 102 includes a first end wall 122, an opposing second end wall 126, a first side wall 128, and a second side wall 130 opposite the first side wall 128. The side walls 128, 130 are oriented perpendicularly to and connect the first end wall 122 and the second end wall 126. A width 132 (FIG. 1) is measured between the first end wall 122 and the second end wall 126 and a thickness 134 (FIG. 2) is measured between the two side walls 128, 130. Suitably, the width 132 of the handle 102 is in the range between about 3.8 mm and about 5.8 mm. In the illustrated embodiment, for example, the width 132 is approximately 4.8 mm. Suitably, the thickness 134 of the handle 102 is in the range between about 1.5 mm and about 2.8 mm. In the illustrated embodiment, for example, the thickness 134 is approximately 1.9 mm.

The toothpick 106, which defines a distal end portion of the handle 102a pick end 107 of the handle 102, facilitates removing and/or loosening debris such as food remnants between the user's teeth. It is contemplated that the toothpick 106 can have any suitable shape that facilitates the removal of debris between adjacent teeth. In the illustrated embodiment, the pick end 107 of the handle 102 is pointed to define the toothpick 106. Specifically, the width of at least one of the side walls 128, 130 tapers to a point towards the pick end 107. In the illustrated embodiment, as best seen in FIG. 1, both the first side wall 128 and the second side wall 130 taper towards the pick end 107. As a result, the first end wall 122 and the second end wall 126 meet at the pick end 107. It is understood that only one of the side walls 128, 130 could taper. For example, in another suitable embodiment, only the second side wall 130 could taper and, in such an embodiment, the first side wall 128 would be generally planar. Additionally, in the illustrated embodiment, the toothpick 106 curves in a direction away from the handle 102, that is, away from the axis 124. It is also contemplated that the toothpick 106 may curve in any other suitable direction, or may be straight.

In the illustrated embodiment, the toothpick 106 is formed as a single piece with the handle 102. In other words, the toothpick 106 is an integral extension of the handle 102. It is understood, however, that the toothpick 106 can be formed as a separate component and attached to the handle 102 during assembly of the dental cleaning tool 100. It is also contemplated that the toothpick 106 can be removably attached to the dental cleaning tool 100 in other suitable embodiments without departing from some aspects of this disclosure.

In the illustrated embodiment, the floss holder 104 extends from the grip portion 114 of the handle 102. The floss holder 104 includes an arcuate (or broadly, nonlinear) base 136 and two arms (an inner arm 138 and an outer arm 140) extending in spaced relationship from each other from the base. As seen in FIG. 1, the inner arm 138 and the outer arm 140 are substantially parallel relative to each other. The floss holder 104 in the illustrated embodiment is generally U-shaped. However, it is understood that in other suitable embodiments, the floss holder 104 may have any suitable shape. At least one floss strand 142 extends between the inner and outer arm 138, 140. For example, in the illustrated embodiment, two floss strands 142 extend between the inner and outer arms 138, 140. Suitably, the floss strands 142 are substantially parallel to each other. It is understood that the floss holder 104 may have any suitable configuration without departing from some aspects of this disclosure. For example, the floss strands 142 may be selectively removable from the inner and outer arms 138, 140 such that the user can manually remove and/or replace the floss strands 142.

In the illustrated embodiment, the floss holder 104 is formed as a single-piece with the handle 102. In other words, the floss holder 104 is an integral extension of the handle 102. It is understood, however, that the floss holder 104 can be formed as a separate component and attached to the handle 102 during assembly of the dental cleaning tool 100.

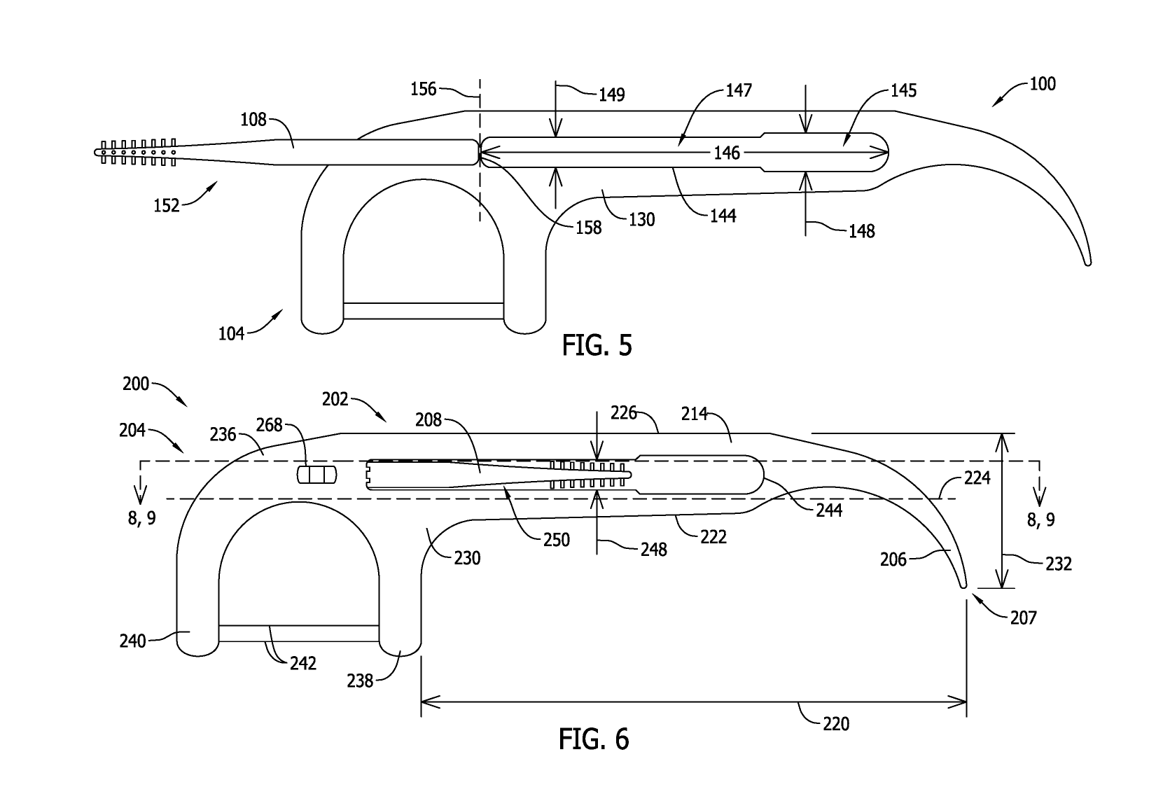

The handle 102, and specifically the grip portion 114, defines a through opening 144. More particularly, the through opening 144 is defined through the first and second side walls 128, 130. As shown in FIGS. 1 and 5, the through opening 144 extends substantially parallel to the longitudinal axis 124. The through opening 144 has a length 146 and a width 148 (FIG. 5) sized to accommodate the pivotable brush tool 108 therein. More specifically, the through opening 144 includes a first portion 145 positioned proximate toothpick 106 and a second portion 147 positioned proximate floss holder 104. In the exemplary embodiment, first portion 145 houses a plurality of bristles 164 of the pivotable brush tool 108 and includes width 148. Second portion 147 houses a rod 162 of the pivotable brush tool 108 and includes a width 149 that is smaller than width 148. In addition, the handle 102 includes a cutout 176 defined therein and positioned adjacent the second portion 147 of the through opening 144. The cutout 176 includes a shape, size, and/or orientation that facilitates receiving an engagement member 174 of the pivotable brush tool 108 therein when the pivotable brush tool 108 is pivoted into the second position 152, as described in further detail below.

The pivotable brush tool 108 is selectively pivotable between a first position 150 (e.g., a stow position, see FIGS. 1 and 2) and a second position 152 (e.g., a use position, see FIG. 5). Generally, the pivotable brush tool 108 is pivotably mounted to and extends along the handle 102. As shown in FIGS. 1 and 2, when the pivotable brush tool 108 is in the first position 150, the pivotable brush tool 108 is positioned within the through opening 144 of the dental cleaning tool 100. More specifically, the plurality of bristles 164 of the pivotable brush tool 108 are positioned in the first portion 145 of the through opening 144 when the pivotable brush tool 108 is in the first position 150. Additionally, the rod 162 of the pivotable brush tool 108 is positioned in the second portion 147 of the through opening 144 when the pivotable brush tool 108 is in the first position 150. Moreover, in the first position 150, the pivotable brush tool 108 is generally parallel to the longitudinal axis 124.

Once the pivotable brush tool 108 is selectively pivoted into the second (use) position 152, the engagement member 174 of the pivotable brush tool 108 engages the cutout 176 in the handle 102 to secure the pivotable brush tool 108 in the second position 152. In the illustrated embodiment, the engagement member 174 includes a pair of projections 178. The pair of projections 178 is suitably configured to engage the cutout 176 in a snap-fit or friction fit to secure the pivotable brush tool 108 in the second position 152. In alternative embodiments, the engagement member 174 may include any other structure(s) suitable to engage the cutout 176 or otherwise secure the pivotable brush tool 108 in the second position 152 (e.g., a snap feature, a hook-and-loop fastener, etc.).

When the pivotable brush tool 108 is in the second position 152, the pivotable brush tool 108 is positioned adjacent one of the side walls 128, 130 of the handle 102. In the illustrated embodiment, the pivotable brush tool 108 extends along and is in contact with the second side wall 130 when in the second position 152. In the illustrated embodiment, the pivotable brush tool 108 extends beyond the transverse extent of the floss holder 104 when in the second position 152. That is, the pivotable brush tool 108 extends transversely along the longitudinal axis 124 beyond a distal end of than the base 136 of the floss holder 104. In addition, in the second position 152, the pivotable brush tool 108 projects from the one of the side walls 128, 130 to which the pivotable brush tool 108 is adjacent.

As illustrated in FIG. 4, the pivotable brush tool 108 is selectively transitionable from the first position 150 to the second position 152. The pivotable brush tool 108 is pivotable through an angle 154 of about 180° between the first position 150 and the second position 152. The pivotable brush tool 108 pivots about a pivot axis 156. In the illustrated embodiment, the pivot axis 156 is located at a first end 158 of the through opening 144. More specifically, the pivot axis 156 is defined by a living hinge 160 that pivotably couples the pivotable brush tool 108 to the handle 102. As used herein, the term “living hinge” is meant to describe a thin flexible hinge (flexure bearing) made from the same material as the two rigid pieces (pivotable brush tool 108 and the handle 102) it connects. Living hinges are typically thinned or cut to allow the rigid pieces to bend along the line of the hinge. The pivotable brush tool 108 may be pivotably coupled to the handle 102 by an alternative coupling element, including an alternative hinge, adhesives, suitable fasteners, or any other suitable coupling element. In an alternative embodiment, the living hinge 160 may be broken such that the pivotable brush tool 108 may be separated from the handle 102 for use and then recoupled to the handle 102 for storage. More specifically, in such an embodiment, the pivotable brush tool 108 may be removed from the handle 102 by breaking the living hinge 160 and the engagement member 174 of the pivotable brush tool 108 may be attached to the handle at the cutout 176 either in the second, use position 152 or in a similar orientation as the first, stow position 150 with the plurality of bristles 164 oriented toward toothpick 106.

In the illustrated embodiment, the pivot axis 156 is substantially perpendicular to the longitudinal axis 124. Such a pivot axis 156 enables the pivotable brush tool 108 to remain substantially parallel to the longitudinal axis 124 in the first and second positions 150, 152. In alternative embodiments, the pivot axis 156 may have any other orientation, and the pivotable brush tool 108 may be otherwise oriented (i.e., may be other than parallel) with respect to the longitudinal axis 124 in one or both of the first and second positions 150, 152. Additionally, although the pivotable brush tool 108 is shown and described as extending from the living hinge 160 at the first end 158 of the through opening, in alternative embodiments, the pivotable brush tool 108 may extend from any portion of the handle 102.

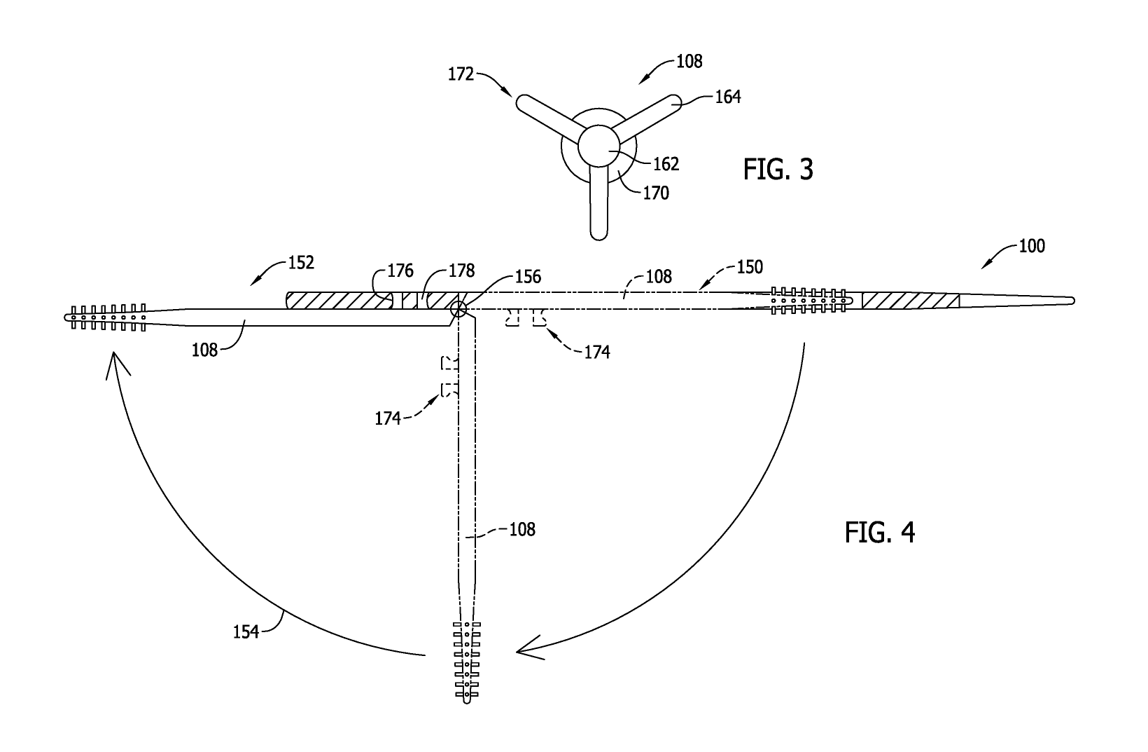

With reference to FIGS. 2 and 3, the illustrated pivotable brush tool 108 includes a rod 162 and a plurality of bristles 164 extending from the rod 162. The rod 162 of pivotable brush tool 108 extends between a proximal end 166, which is generally defined at the pivot axis 156, and a distal end 168. Suitably, the rod 162 is of a cylindrical shape with a sidewall 170 extending from the proximal end 166 to the distal end 168. In the illustrated embodiment, the sidewall 170 is of a tapering cylindrical shape. More specifically, the rod 162 is tapered from a point between the proximal end 166 and the distal end 168 to the distal end 168.

The bristles 164 extend from the rod 162 for cleaning the user's teeth. The bristles 164 may be arranged in any suitable manner. In the illustrated embodiment, the bristles 164 are arranged in a plurality of bristle groups 172 spaced along at least a portion of the length of the rod 162 at the distal end 168 of the rod. The bristles 164 of bristle groups 172 are spaced annularly around the circumference of the rod 162. In other suitable embodiments, the bristles 164 may be continuous along the length and/or circumference of the rod 162 instead of being arranged in the spaced bristle groups 172. It is understood that the bristles 164 can be grouped in any suitable manner or can be arranged in any manner on the rod 162.

Once the pivotable brush tool 108 is selectively pivoted to the second position 152, the user can comfortably use the pivotable brush tool 108 to clean their teeth. In particular, the user can comfortably hold the handle 102 and position the pivotable brush tool 108 between their teeth without having to awkwardly position their hand in relation to their mouth or awkwardly position the dental cleaning tool 100 within their mouth. Additionally, the pivotable brush tool 108 facilitates the dental cleaning tool 100 to reach difficult locations in a user's mouth (e.g., the back of the user's mouth). Moreover, the dental cleaning tool 100 is configured such that the pivotable brush tool 108 can be positioned without being obstructed by the floss holder 104 and vice-versa. In the illustrated embodiment, the pivotable brush tool 108 may be selectively transitioned from the second position 152 to the first position 150 by disengaging the engagement member 174 from the cutout 176 and pivoting or rotating the pivotable brush tool 108 back into the through opening 144 in the handle 102.

In suitable embodiments, the dental cleaning tool 100 may be formed in any suitable manner and of any suitable material. For example, the dental cleaning tool 100 may be formed from metal, wood, plastic, and/or combinations thereof. In one preferred embodiment, at least the handle 102, the floss holder 104, and the toothpick 106 of the dental cleaning tool 100 are molded or otherwise formed from a single piece of resilient synthetic material, such as, but not limited to, plastic or metal. In the illustrated embodiment, the handle 102, the floss holder 104, and the toothpick 106 are integrally formed. More specifically in the illustrated embodiment, the dental cleaning tool 100, except for the floss strands 142 and the pivotable brush tool 108, is molded as a single piece from acceptable food grade plastic. In other embodiments, any of the handle 102, the floss holder 104, the toothpick 106, and pivotable brush tool 108 may be separately formed and attached to the dental cleaning tool 100 during assembly.

FIGS. 6-9 illustrate another suitable embodiment of a dental cleaning tool, indicated generally at 200. As seen therein, the illustrated dental cleaning tool 200 includes a handle 202, a floss holder 204, an integrally formed toothpick 206, and a detachable brush tool 208 (broadly, a “detachable dental tool”). The dental cleaning tool 200 is similar to the dental cleaning tool 100 shown in FIGS. 1-5. However, the dental cleaning tool 200 includes the detachable brush tool 208 instead of the pivotable brush tool 108. It is understood that in some other suitable embodiments that do not depart from some of the aspects of this disclosure, the dental cleaning tool 200 may include any combination(s) of the floss holder 204, the toothpick 206, and the detachable brush tool 208. It is further contemplated that although the detachable dental tool is shown and described as a brush, the detachable dental tool may alternatively including another dental tool, such as a toothpick tool or floss tool, without departing from the scope of the present disclosure.

As illustrated in FIG. 6, the handle 202 includes a grip portion 214 positioned between the floss holder 204 and the toothpick 206. In the illustrated embodiment, the handle 202 has a length 220 measured between the floss holder 204 and a pick end 207 of the toothpick 206 along a longitudinal axis 224 of the dental cleaning tool 200, which extends through the handle 202. In suitable embodiments, the length 220 of the handle 202 may be any measurement that enables the dental cleaning tool 200 to function as described herein. Suitably, the length 220 is in the range between about 43 mm and about 52 mm. In the illustrated embodiment, for example, the length 220 of the handle 202 is approximately 48 mm.

In the illustrated embodiment and as best seen in FIGS. 6 and 8, the handle 202 includes a first end wall 222, an opposing second end wall 226, a first side wall 228, and a second side wall 230 opposite the first side wall 228. The side walls 228, 230 are oriented perpendicularly to and connect the first end wall 222 and the second end wall 226. A width 232 (FIG. 6) is measured between the first end wall 222 and the second end wall 226 and a thickness 234 (FIG. 8) is measured between the two side walls 228, 230. Suitably, the width 232 of the handle 202 is in the range between about 3.8 mm and about 5.8 mm. In the illustrated embodiment, for example, the width 232 is approximately 4.8 mm. Suitably, the thickness 234 of the handle 202 is in the range between about 1.5 mm and about 2.8 mm. In the illustrated embodiment, for example, the thickness 234 is approximately 1.9 mm.

The toothpick 206, which defines a distal end portion of the handle 202 and, more specifically, defines the pick end 207 of the handle 202, facilitates removing and/or loosening debris such as food remnants between the user's teeth. It is contemplated that the toothpick 206 can have any suitable shape that facilitates the removal of debris between adjacent teeth. In the illustrated embodiment, the pick end 207 of the handle 202 is pointed to define the toothpick 206. Specifically, the width of at least one of the side walls 228, 230 tapers to a point towards the pick end 207. In the illustrated embodiment, as best seen in FIG. 6, both the first side wall 228 and the second side wall 230 taper towards the pick end 207. As a result, the first end wall 222 and the second end wall 226 meet at the pick end 218. It is understood that only one of the side walls 228, 230 could taper. For example, in another suitable embodiment, only the second side wall 230 could taper and, in such an embodiment, the first side wall 228 would be generally planar. Additionally, in the illustrated embodiment, the toothpick 206 curves in a direction away from the handle 102, that is, away from the axis 124. It is also contemplated that the toothpick 206 may curve in any other suitable direction, or may be straight.

In the illustrated embodiment, the toothpick 206 is formed as a single piece with the handle 202. In other words, the toothpick 206 is an integral extension of the handle 202. It is understood, however, that the toothpick 206 can be formed as a separate component and attached to the handle 202 during assembly of the dental cleaning tool 200. It is also contemplated that the toothpick 206 can be removably attached to the dental cleaning tool 200 in other suitable embodiments without departing from some aspects of this disclosure.

In the illustrated embodiment, the floss holder 204 extends from the handle 202 opposite the toothpick 206. The floss holder 204 includes an arcuate (or broadly, nonlinear) base 236 and two arms (an inner arm 238 and an outer arm 240) extending in spaced relationship from each other from the base. As seen in FIG. 6, the inner arm 238 and the outer arm 240 are substantially parallel relative to each other. The floss holder 204 in the illustrated embodiment is generally U-shaped. However, it is understood that in other suitable embodiments, the floss holder 204 may have any suitable shape. At least one floss strand 242 extends between the inner and outer arm 238, 240. For example, in the illustrated embodiment, two floss strands 242 extend between the inner and outer arms 238, 240. Suitably, the floss strands 242 are substantially parallel to each other. It is understood that the floss holder 204 may have any suitable configuration without departing from some aspects of this disclosure. For example, the floss strands 242 may be selectively removable from the inner and outer arms 238, 240 such that the user can manually remove and/or replace the floss strands 242.

In the illustrated embodiment, the floss holder 204 is formed as a single-piece with the handle 202. In other words, the floss holder 204 is an integral extension of the handle 202. It is understood, however, that the floss holder 204 can be formed as a separate component and attached to the handle 202 during assembly of the dental cleaning tool 200.

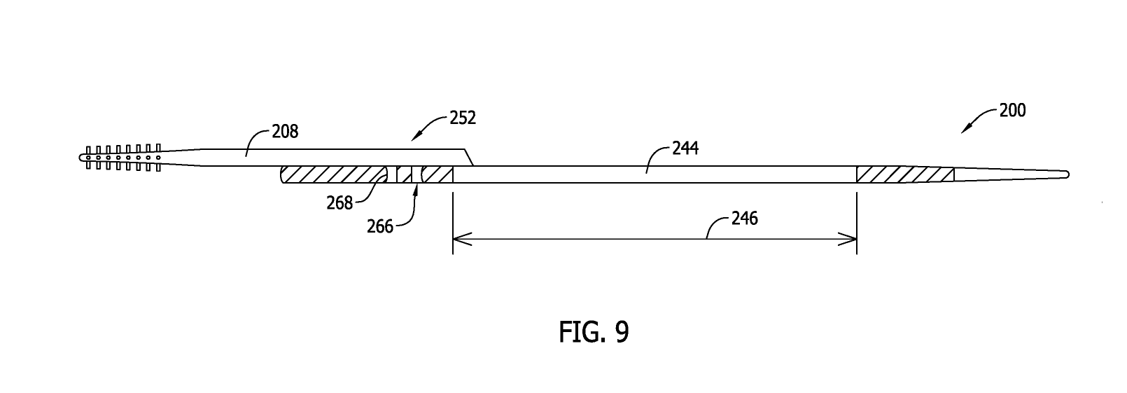

The handle 202, and specifically the grip portion 214, defines a through opening 244. More particularly, the through opening 244 is defined through the first and second side walls 228, 230. As shown in FIGS. 6, 8, and 9, the through opening 244 extends substantially parallel to the longitudinal axis 224. The through opening 244 has a length 246 (FIG. 9) and a width 248 (FIG. 6) sized to accommodate the detachable brush tool 208 therein. In addition, the handle 202 includes a cutout 268 defined therethrough and positioned proximate the floss holder 204. The cutout 268 includes a shape, size, and/or orientation that facilitates receiving an engagement member 266 of the detachable brush tool 208 therein when the detachable brush tool 208 is pivoted into the second position 252, as described in further detail below.

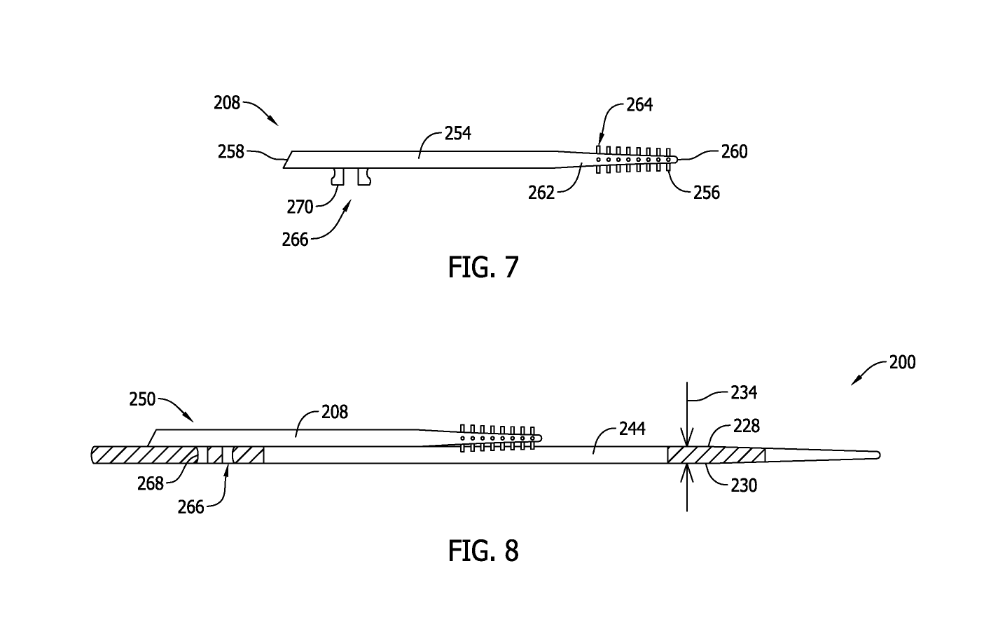

The detachable brush tool 208 is selectively movable between a first position 250 (e.g., a stow position, see FIGS. 6 and 8) and a second position 252 (e.g., a use position, see FIG. 9). Generally, the detachable brush tool 208 is removably mounted to and extends along the handle 202. With reference specifically to FIG. 7, the detachable brush tool 208 includes a rod 254 and a plurality of bristles 256 extending from the rod 254. The rod 254 of detachable brush tool 208 extends between a first end 258 and a second end 260. Suitably, the rod 254 is of a cylindrical shape with a sidewall 262 extending from the first end 258 to the second end 260. In the illustrated embodiment, the sidewall 262 is of a tapering cylindrical shape. More specifically, the rod 254 is tapered from a point between the first end 258 and the second end 260 to the second end 260.

The bristles 256 extend from the rod 254 for cleaning the user's teeth. The bristles 256 may be arranged in any suitable manner. In the illustrated embodiment, the bristles 256 are arranged in a plurality of bristle groups 264 spaced along at least a portion of the length of the rod 254 at the second end 260 of the rod 254. The bristles 256 of bristle groups 264 are spaced annularly around the circumference of the rod 254. In other suitable embodiments, the bristles 256 may be continuous along the length and/or circumference of the rod 254 instead of being arranged in the spaced bristle groups 264. It is understood that the bristles 256 can be grouped in any suitable manner or can be arranged in any manner on the rod 254.

In the illustrated embodiment, the engagement member 266 of the detachable brush tool 208 engages the cutout 268 on the handle 202 to secure the detachable brush tool 208 in the first position 250. In addition, the engagement member 266 engages the cutout 268 to secure the detachable brush tool 208 in the second position 252. It is contemplated that a user may detach detachable brush tool 208 from the handle 202 and use the detachable brush tool 208 without re-coupling the detachable brush tool 208 to the handle 202. In other words, such a user may not couple the detachable brush tool 208 to the handle 202 in the illustrated second position 252. In the illustrated embodiment, the engagement member 266 includes a pair of projections 270. The pair of projections 270 is suitably configured to engage the cutout 268 in a snap-fit or friction fit to secure the detachable brush tool 208 in the first position 250 and/or the second position 252. In alternative embodiments, the engagement member 266 may include any other structure(s) suitable to engage the cutout 268 or otherwise secure the detachable brush tool 208 to the handle 202 (e.g., a snap feature, a hook-and-loop fastener, etc.).

As shown in FIGS. 6 and 8, when the detachable brush tool 208 is in the first position 250, the detachable brush tool 208 is substantially parallel to the longitudinal axis 224. In addition, the detachable brush tool 208 is positioned adjacent one of the side walls 228, 230 of the handle 202. In the illustrated embodiment, the detachable brush tool 208 is disposed, in its entirety, along the first side wall 228 when in the first position 250. In the first position 250, the detachable brush tool 208 projects from the one of the side walls 228, 230 to which the detachable brush tool 208 is adjacent. As shown in FIG. 9, when detachable brush tool 208 is in the second position 252, the detachable brush tool 208 is substantially parallel to the longitudinal axis 224. In addition, the detachable brush tool 208 is positioned adjacent one of the side walls 228, 230 of the handle 202. In the illustrated embodiment, the detachable brush tool 208 is disposed along the first side wall 228 when in the second position 252. In the illustrated embodiment, the detachable brush tool 208 extends beyond the transverse extent of the floss holder 204 when in the second position 252. That is, the detachable brush tool 208 extends transversely along the longitudinal axis 224 a greater distance than the base 236 of the floss holder 204. In the second position 252, the detachable brush tool 208 projects from the one of the side walls 228, 230 to which the detachable brush tool 208 is adjacent.

As illustrated in FIGS. 8 and 9, the detachable brush tool 208 is selectively transitionable from the first position 250 to the second position 252. To transition the detachable brush tool 208 from the first position to the second position 252, the detachable brush tool 208 is de-coupled from the handle 202 (i.e., the engagement member 266 is disengaged from the cutout 268) and rotated about 180° (e.g., about a pivot point centered on the engagement member 266). The engagement member 266 is re- aligned with the cutout 268, and the detachable brush tool 208 is urged towards the handle 202 until the engagement member 266 re-engages with the cutout 268. The process can be reversed to transition the detachable brush tool 208 from the second position 252 back to the first position 250.

Once the detachable brush tool 208 is mounted to the handle 202 in the second position 252, the user can comfortably use the detachable brush tool 208 to clean their teeth. In particular, the user can comfortably hold the handle 202 and position the detachable brush tool 208 between or against their teeth without having to awkwardly position their hand in relation to their mouth or awkwardly position the dental cleaning tool 200 within their mouth. Additionally, the detachable brush tool 208 facilitates the dental cleaning tool 200 to reach difficult locations in a user's mouth (e.g., the back of the user's mouth). Moreover, the dental cleaning tool 200 is configured such that the detachable brush tool 208 can be positioned without being obstructed by the floss holder 204 and vice- versa.

In suitable embodiments, the dental cleaning tool 200 may be formed in any suitable manner and of any suitable material. For example, the dental cleaning tool 200 may be formed from metal, wood, plastic, and/or combinations thereof. In one preferred embodiment, at least the handle 202, the floss holder 204, and the toothpick 206 of the dental cleaning tool 200 are molded or otherwise formed from a single piece of resilient synthetic material, such as, but not limited to, plastic or metal. In the illustrated embodiment, the handle 202, the floss holder 204, and the toothpick 206 are integrally formed. More specifically in the illustrated embodiment, the dental cleaning tool 200, except for the floss strands 242 and the detachable brush tool 208, is molded as a single piece from acceptable food grade plastic. In other embodiments, any of the handle 202, the floss holder 204, the toothpick 206, and the detachable brush tool 208 may be separately formed and attached to the dental cleaning tool 200 during assembly.

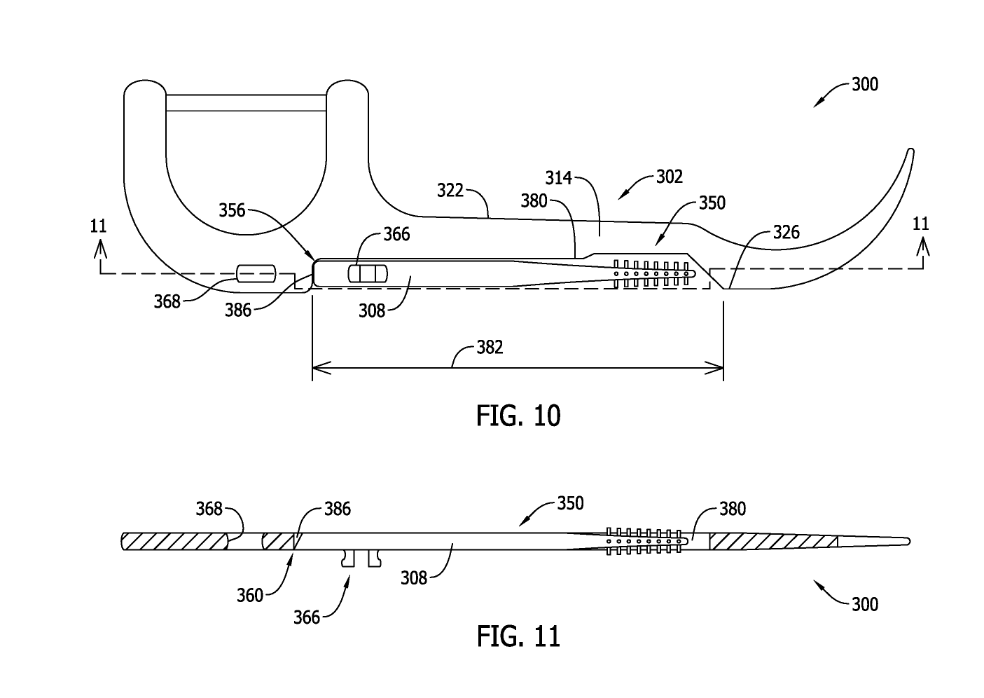

FIGS. 10-12 illustrate another suitable embodiment of a dental cleaning tool, indicated generally at 300. The dental cleaning tool 300 is identical to the dental cleaning tool 100 (shown in FIGS. 1-5) in operation and structure with the exception that dental cleaning tool 300 includes a notch 380 instead of the through opening 144. As such, components of the dental cleaning tool 300 shown in FIGS. 10-12 are labeled with similar reference numbers as those used to describe the dental cleaning tool 100 in FIGS. 1-5 with the exception that the reference numbers are in the 300 series.

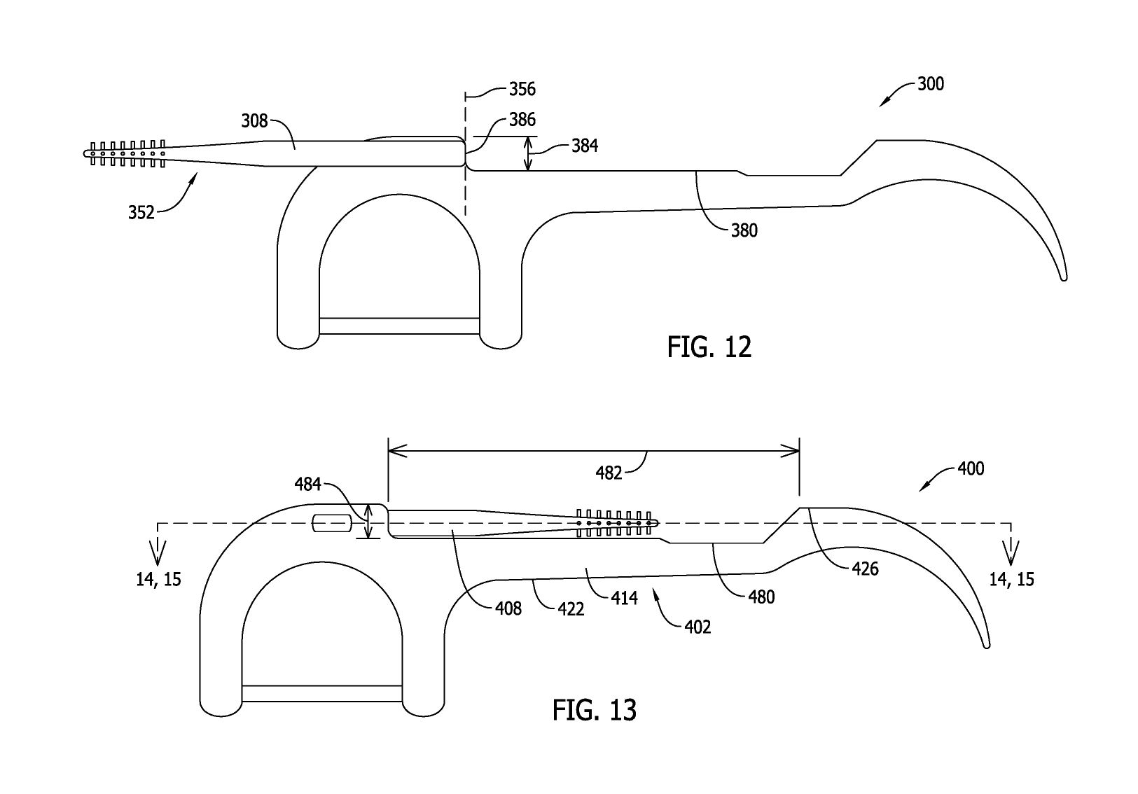

As shown in FIGS. 10 and 12, a handle 302 of the dental cleaning tool 300, and specifically a grip portion 314 thereof, defines a notch 380 therein. More particularly, the notch 380 is defined in a second end wall 326 of the handle 302 and extends into (i.e., towards a first end wall 322 of) the grip portion 314. The notch 380 has a length 382 and a width 384 (FIG. 12) sized to accommodate a pivotable brush tool 308 therein.

The pivotable brush tool 308 is selectively pivotable between a first position 350 (e.g., a stow position, see FIGS. 10 and 11) and a second position 352 (e.g., a use position, see FIG. 12). Generally, the pivotable brush tool 308 is pivotably mounted to and extends along the handle 302. As shown in FIGS. 10 and 11, when the pivotable brush tool 308 is in the first position 350, the pivotable brush tool 308 is positioned within the notch 380 of the dental cleaning tool 300.

In addition, the pivotable brush tool 308 includes an engagement member 366, and the handle 302 defines a cutout 368 therein. The cutout 368 includes a shape, size, and/or orientation such that the cutout 368 may receive the engagement member 366 therein. In the illustrated embodiment, the engagement member 366 engages the cutout 368 to secure the detachable brush tool 308 in the second position 352.

The pivotable brush tool 308 is selectively transitionable from the first position 350 to the second position 352. The pivotable brush tool 308 is pivotable through an angle (not specifically shown) of about 180° between the first position 350 and the second position 352. The pivotable brush tool 308 pivots about a pivot axis 356. In the illustrated embodiment, the pivot axis 356 is defined at a first end 386 of the notch 380. More specifically, the pivot axis 356 is defined by a living hinge 360 (FIG. 11) that pivotably couples the pivotable brush tool 308 to the handle 302. The pivotable brush tool 308 may be pivotably coupled to the handle 302 by an alternative coupling element, including an alternative hinge, adhesives, suitable fasteners, or any other suitable coupling element.

FIGS. 13-15 illustrate another suitable embodiment of a dental cleaning tool, indicated generally at 400. The dental cleaning tool 400 is identical to the dental cleaning tool 200 (shown in FIGS. 6-9) in operation and structure with the exception that dental cleaning tool 400 includes a notch 480 instead of the through opening 244. As such, components of the dental cleaning tool 400 shown in FIGS. 13-15 are labeled with similar reference numbers as those used to describe the dental cleaning tool 200 in FIGS. 6-9 with the exception that the reference numbers are in the 400 series.

As shown in FIGS. 13-15, a handle 402 of the dental cleaning tool 400, and specifically a grip portion 414 thereof, defines a notch 480 therein. More particularly, the notch 480 is defined in a second end wall 426 of the handle 402 and extends into (i.e., towards a first end wall 422 of) the grip portion 414. The notch 480 has a length 482 and a width 484.

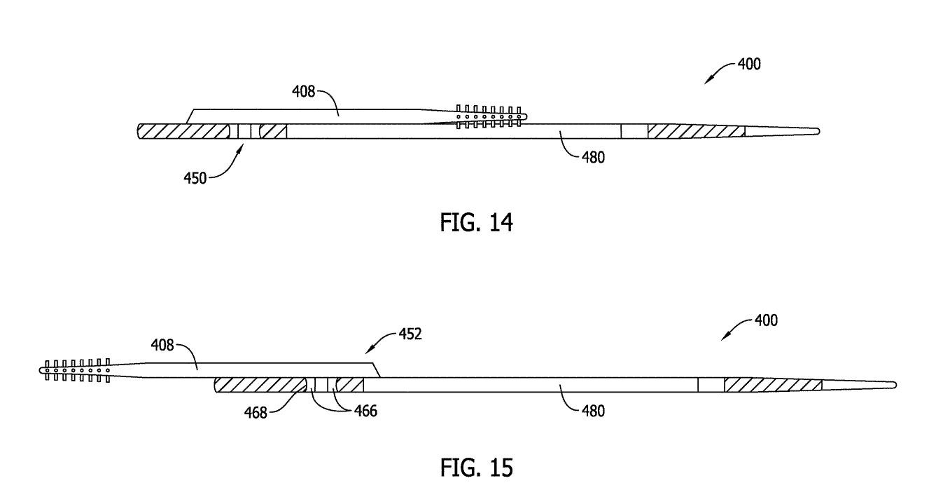

The dental cleaning tool 200 includes a detachable brush tool 408 that is selectively movable between a first position 450 (e.g., a stow position, see FIGS. 13 and 14) and a second position 452 (e.g., a use position, see FIG. 15). Generally, the detachable brush tool 408 is removably mounted to and extends along the handle 402.

In addition, the detachable brush tool 408 includes an engagement member 466, and the handle 402 defines a cutout 468 therein. The cutout 468 includes a shape, size, and/or orientation such that the cutout 468 may receive the engagement member 466 therein. In the illustrated embodiment, the engagement member 466 engages the cutout 468 to secure the detachable brush tool 408 in the first position 450. In addition, the engagement member 466 engages the cutout 468 to secure the detachable brush tool 408 in the second position 452. It is contemplated that a user may detach detachable brush tool 408 from the handle 402 and use the detachable brush tool 408 without re-coupling the detachable brush tool 408 to the handle 402. In other words, such a user may not couple the detachable brush tool 408 to the handle 402 in the illustrated second position 452.

As illustrated in FIGS. 13-15, the detachable brush tool 408 is selectively transitionable from the first position 450 to the second position 452. To transition the detachable brush tool 408 from the first position to the second position 452, the detachable brush tool 408 is de-coupled from the handle 402 (i.e., the engagement member 466 is disengaged from the cutout 468) and rotated about 180° (e.g., about a pivot point centered on the engagement member 466). The engagement member 466 is re- aligned with the cutout 468, and the detachable brush tool 408 is urged towards the handle 402 until the engagement member 466 re-engages with the cutout 468. The process can be reversed to transition the detachable brush tool 408 from the second position 452 back to the first position 450.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A dental cleaning tool comprising:
a handle defining a longitudinal axis of the dental cleaning tool;
a floss holder having at least one strand of floss coupled thereto;
a toothpick spaced from the floss holder such that the handle is disposed between the toothpick and the floss holder; and
a pivotable dental tool pivotably coupled to the handle, the pivotable dental tool being selectively moveable between a first, stow position and a second, use position about a pivot axis perpendicular to the longitudinal axis of the handle.

2. The dental cleaning tool in accordance with claim 1, wherein the pivotable dental tool pivots between the first, stow position and the second, use position about a living hinge that defines the pivot axis of the pivotable dental tool.

3. The dental cleaning tool in accordance with claim 2, wherein the handle defines a through opening therethrough, and wherein the pivotable dental tool is positioned within the through opening in the first, stow position.

4. The dental cleaning tool in accordance with claim 3, wherein the living hinge is defined at a first end of the pivotable dental tool proximate a first end of the through opening.

5. The dental cleaning tool in accordance with claim 2, wherein the handle comprises an end wall and the end wall defines a notch therein.

6. The dental cleaning tool in accordance with claim 5, wherein the living hinge is defined at a first end of the pivotable dental tool proximate a first end of the notch.

7. The dental cleaning tool in accordance with claim 1, wherein the pivotable dental tool comprises an engagement member configured to selectively engage with the handle when the pivotable dental tool is in the second, use position.

8. The dental cleaning tool in accordance with claim 7, wherein the engagement member includes at least one projection projecting from the pivotable dental tool, the handle defines a cutout therein, and the at least one projection engages the cutout when the pivotable dental tool is in the second, use position.

9. The dental cleaning tool in accordance with claim 1, wherein the pivotable dental tool pivots about 180° between the first, stow position and the second, use position.

10. The dental cleaning tool in accordance with claim 1, wherein the pivotable dental tool is oriented parallel to the longitudinal axis of the handle in the first, stow position and the second, use position.

11. A dental cleaning tool comprising:
a handle defining a longitudinal axis of the dental cleaning tool;
a floss holder having at least one strand of floss coupled thereto;
a toothpick spaced from the floss holder such that the handle is disposed between the toothpick and the floss holder; and
a detachable dental tool selectively moveable between a first, stow position in which the detachable dental tool is removably coupled to the handle and a second, use position, wherein the detachable dental tool comprises an engagement member configured to engage with a cutout defined on the handle to secure the detachable dental tool in the first, stow position..

12. The dental cleaning tool in accordance with claim 11, wherein the engagement member includes at least one projection projecting from the detachable dental tool, and the at least one projection engages the cutout to secure the detachable dental tool in the first, stow position.

13. The dental cleaning tool in accordance with claim 11, wherein the detachable dental tool is oriented parallel to the longitudinal axis of the handle in the first, stow position.

14. The dental cleaning tool in accordance with claim 11, wherein the detachable dental tool projects from a side wall of the handle when the detachable dental tool is in the first, stow position.

15. The dental cleaning tool in accordance with claim 11, wherein the detachable dental tool is coupled to the handle in the second, use position.

16. The dental cleaning tool in accordance with claim 15, wherein the detachable dental tool is oriented parallel to the longitudinal axis of the handle in the second, use position.

17. A dental cleaning tool comprising:
a handle defining a longitudinal axis of the dental cleaning tool;
a floss holder having at least one strand of floss coupled thereto;
a toothpick spaced from the floss holder such that the handle is disposed between the toothpick and the floss holder; and
a moveable dental tool coupled to the handle, the moveable dental tool being selectively moveable between a first, stow position and a second, use position about a pivot axis perpendicular to the longitudinal axis of the handle, wherein a distal end of the moveable dental tool extends beyond the floss holder in the second, use position.

18. The dental cleaning tool in accordance with claim 17, wherein the pivotable dental tool comprises an engagement member configured to selectively engage with the handle when the pivotable dental tool is in the second, use position.

19. The dental cleaning tool in accordance with claim 18, wherein the engagement member includes at least one projection projecting from the pivotable dental tool and configured to engage a cutout defined in the handle when the pivotable dental tool is in the second, use position.

20. The dental cleaning tool in accordance with claim 17, wherein the pivotable dental tool is oriented parallel to the longitudinal axis of the handle in the first, stow position and the second, use position.
